(19) United States
(12) Patent Application Publication
(10) Pub. No.: US 2025/0336242 A1
(43) Pub. Date: Oct. 30, 2025

(54) System and Method for Remotely Monitoring Marine Vessel Data Using NMEA 0183 and NMEA 2000 Data Standards

(71) Applicants: Thomas Owen, Witney (GB); Simon Rathbone, Witney (GB)

(72) Inventors: Thomas Owen, Witney (GB); Simon Rathbone, Witney (GB)

(21) Appl. No.: 18/646,625

(22) Filed: Apr. 25, 2024

(51) Int. Cl. G07C 5/00; H04L 12/40

(52) U.S. Cl. CPC G07C 5/008; H04L 12/40052; H04L 2012/40215; H04L 2012/40286

(57) ABSTRACT

A system and method for remotely monitoring marine vessel data using NMEA 0183 and NMEA 2000 data standards. The system comprises a computing device with communication interfaces for connecting to a vessel's NMEA 0183 and NMEA 2000 data systems and internet connection, a data cache for storing vessel data, and a software application. The software application receives vessel data via the interfaces, transmits it in real-time to a remote server using the internet connection, stores it in the data cache when the internet is unavailable, and transmits stored data upon reconnection. The software can also receive user-specified configuration settings from the remote server to control data transmission. The method enables secure, real-time remote access to vessel data, facilitating vessel tracking and performance monitoring without relying on traditional methods.

### BACKGROUND

The present invention relates to the field of marine vessel monitoring and, more specifically, to systems and methods for remotely accessing and monitoring vessel data using the NMEA 0183 and NMEA 2000 data standards.

Marine vessels are equipped with a variety of electronic navigation and monitoring systems that generate data using the NMEA 0183 and NMEA 2000 data standards. NMEA 0183 is a serial data interface standard that defines how data is transmitted in a “sentence” from one “talker” to multiple “listeners” at a time. NMEA 2000 is a newer, plug-and-play communications standard that connects marine sensors and displays on a CAN (Controller Area Network) bus.

Traditionally, NMEA data has been confined to onboard systems and could only be accessed by the crew physically present on the vessel. This limitation poses challenges for vessel owners, fleet managers, and other stakeholders who need to monitor vessel performance, track vessel location, and ensure the safety and security of the vessel and its crew.

Several prior art systems have attempted to address the need for remote monitoring of marine vessels. For example, U.S. Pat. No. 7,327,286 B2 to Thibault et al. discloses a marine vessel monitoring system that uses sensors to monitor various equipment onboard and generates an output when a monitored value exceeds a predetermined threshold. However, this system does not specifically interface with NMEA data systems and does not include a data cache for storing data when an internet connection is unavailable.

Another example is Chinese Patent No. CN106125657A, which describes a remote monitoring and real-time maintenance management system for boats and ships. This system uses image acquisition modules and a fuel monitoring unit to collect data, which is then transmitted via a GPRS wireless module. However, like the Thibault patent, this system does not interface with NMEA data systems and does not include a data caching feature.

U.S. Patent Application Publication No. 2005/0076147 A1 to Wiley et al. discloses a method for transporting NMEA 0183 data over Ethernet. While this system does interface with NMEA 0183 data, it does not include the NMEA 2000 interface, data caching, and remote access features of the present invention.

In summary, while the prior art includes various systems for monitoring and transmitting marine vessel data, none of these systems include the combination of features found in the present invention. Specifically, the present invention is distinguished by its ability to interface with both NMEA 0183 and NMEA 2000 data systems, cache data when an internet connection is unavailable, transmit cached data upon reconnection, and provide secure remote access to authorized users. These features provide a novel and non-obvious solution to the problem of remotely monitoring marine vessel data in real-time.

### SUMMARY

The present invention is directed to a system and method for remotely monitoring marine vessel data using NMEA 0183 and NMEA 2000 data standards. The present invention, addresses the problem of NMEA data being confined to onboard systems and not accessible remotely from shore. By enabling secure, real-time remote access to a vessel's NMEA data, the invention facilitates vessel tracking and performance monitoring without relying on traditional methods like AIS and SAT-C.

In one embodiment, the present invention comprises a computing device, such as a Raspberry Pi, equipped with a plurality of communication interfaces for connecting to a vessel's NMEA 0183 and NMEA 2000 data systems, as well as the vessel's internet connection. The computing device runs proprietary software that receives NMEA data via the communication interfaces, processes the data, and transmits it securely to a remote server using the vessel's internet connection.

Additionally, the present invention includes a data cache for storing NMEA data when the vessel's internet connection is unavailable. Upon reconnection, the software automatically transmits the cached data to the remote server, ensuring data continuity. Authorized users can remotely access the live NMEA data feed and configure data selection and transmission settings as needed.

The present invention offers several advantages over prior art systems. It enables secure remote access to live NMEA data from shore, allows vessel tracking without relying on vulnerable AIS or expensive satellite systems, and enables remote monitoring of vessel performance and troubleshooting. The invention is configurable, allowing users to select which data is transmitted and at what frequency. It also integrates seamlessly with existing vessel internet and NMEA data systems.

In summary, the present invention represents a significant advancement in the field of marine vessel monitoring by providing a novel solution for remotely accessing a vessel's NMEA navigation and system data in real-time. The invention's unique combination of features, including its ability to interface with both NMEA 0183 and NMEA 2000 data systems, cache data during internet outages, and provide secure remote access, distinguishes it from prior art systems and offers a valuable tool for vessel owners, fleet managers, and other stakeholders in the marine industry.

### BRIEF DESCRIPTION OF THE DRAWINGS

The various exemplary embodiments of the present invention. which will become more apparent as the description proceeds, are described in the following detailed description in conjunction with the accompanying drawings, in which:

FIG. 1 is a system overview diagram illustrating the key components of the system for remotely monitoring marine vessel data.

FIG. 2 is a detailed diagram of the computing device hardware components and their interconnections.

FIG. 3 is a flowchart illustrating the operation of the computing device software application.

FIG. 4 is a illustrative view of the hardware system depicting an embodiment of the system in physical form.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein. each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might.” or “may.” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

A computing device herein, refers to any electronic device comprising at least a processor and a memory, the processor configured to execute instructions stored in the memory to perform various functions. Examples of computing devices include, but are not limited to, personal computers, servers, laptops, tablets, smartphones, embedded systems, and single-board computers such as Raspberry Pi devices. The computing device may include additional components such as input/output interfaces, communication interfaces, and storage devices.

A communication interface herein, refers to a hardware and/or software component that enables a computing device to communicate with other devices, systems, or networks. The communication interface facilitates the transmission and reception of data signals. Examples of communication interfaces include, but are not limited to, network interface cards (NICs), wireless network adapters, serial ports, parallel ports, USB ports, Ethernet ports, Bluetooth transceivers, and Wi-Fi transceivers. The communication interface may support various communication protocols and standards such as TCP/IP, HTTP, FTP, SMTP, NMEA 0183, NMEA 2000, and CAN bus.

A data cache herein, refers to a high-speed memory component that stores frequently accessed data, enabling faster retrieval compared to accessing the data from its original source or slower storage. The data cache acts as an intermediary between a computing device's processor and main memory or storage, reducing latency and improving overall system performance. Data caches can be implemented in hardware, such as CPU caches (L1, L2, L3) and disk caches, or in software, such as in-memory caches used by databases and web applications. When data is requested, the cache is checked first, and if the data is found (cache hit), it is retrieved from the cache; otherwise (cache miss), the data is fetched from the original source and may be stored in the cache for future access.

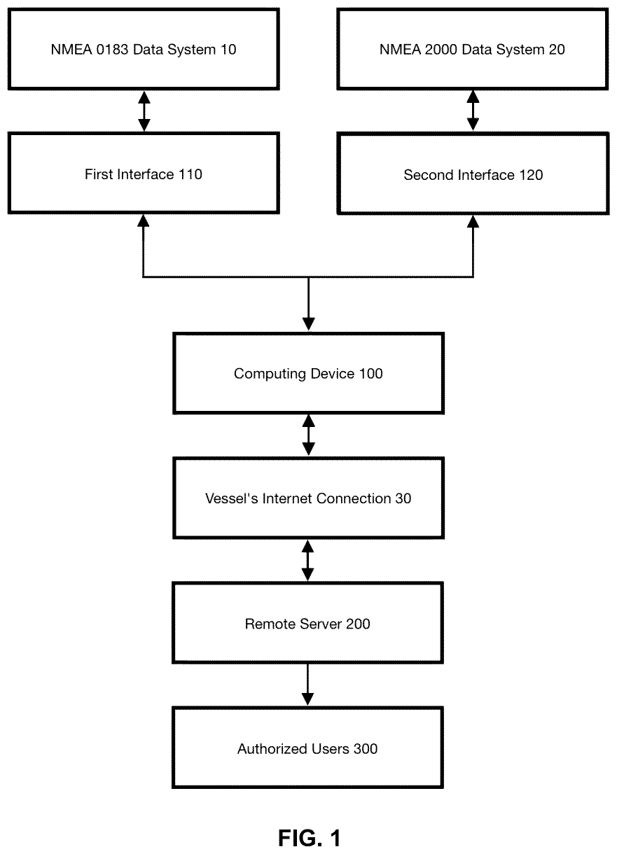

FIG. 1 is a system overview diagram illustrating the key components of the system for remotely monitoring marine vessel data. The system includes a computing device 100 installed on a marine vessel. The computing device 100 comprises a computing device having a processor, a memory, and a plurality of communication interfaces. The communication interfaces include a first interface 110 configured to connect to the vessel's NMEA 0183 data system 10, a second interface 120 configured to connect to the vessel's NMEA 2000 data system 20, and a third interface 130 configured to connect to the vessel's internet connection 30. The computing device 100 further includes a data cache configured to store vessel data received from the NMEA 0183 data system 10 and NMEA 2000 data system 20. A software application is stored in the memory and executed by the processor. The software application is configured to receive the vessel data via the first interface 110 and second interface 120, transmit the vessel data in real-time to a remote server 200 via the third interface 130 using the vessel's internet connection 30, store the vessel data in the data cache when the internet connection 30 is unavailable, and transmit the stored vessel data to the remote server 200 upon reconnection of the internet connection 30. The remote server 200 provides remote access to the vessel data to authorized users 300. The software application is further configured to receive user-specified configuration settings from the remote server 200, the configuration settings defining the vessel data to be transmitted and a transmission frequency. The software application applies the configuration settings to control the transmission of the vessel data.

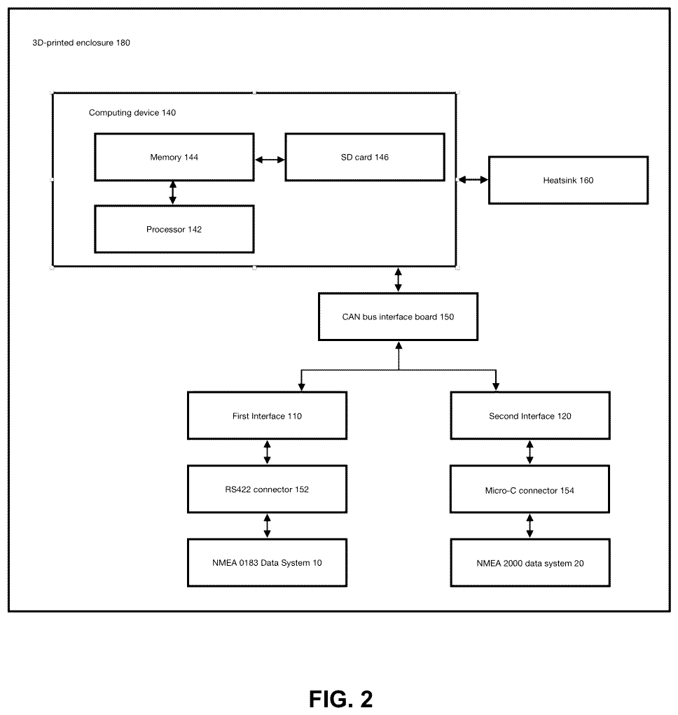

FIG. 2 is a detailed diagram of the computing device hardware components and their interconnections. The computing device 100 comprises a single board computing device 140, such as a Raspberry Pi, mounted within an enclosure 180. The enclosure 180 may be a custom 3D-printed enclosure or a stock enclosure provided with a CAN bus interface board 150. The CAN bus interface board 150, such as a PiCAN-M board, is communicatively coupled to the computing device 140. The CAN bus interface board 150 provides the first interface 110 for connecting to the vessel's NMEA 0183 data system 10 via an RS422 connector 152, and the second interface 120 for connecting to the vessel's NMEA 2000 data system 20 via a Micro-C connector 154. The computing device 140 includes a processor 142, memory 144, and an SD card 146 for storing the software application and data cache. A heatsink 160 is attached to the processor 142 for thermal management. The third interface 130 is provided by the computing device 140 for connecting to the vessel's internet connection 30.

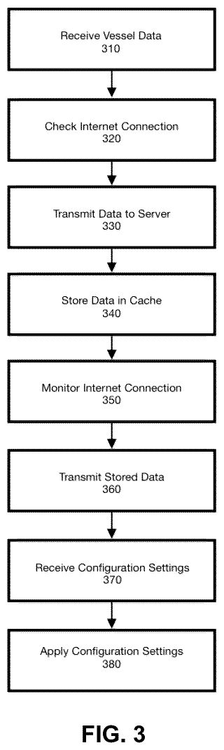

FIG. 3 is a flowchart illustrating the operation of the computing device software application, which may be implemented using Java for as the primary coding language and Artemis for caching. The process begins with the software application, written in Java, receiving vessel data from the NMEA 0183 data system 10 and NMEA 2000 data system 20 via the first interface 110 and second interface 120, respectively (310). The received data may be parsed using proprietary code. The software application checks the availability of the vessel's internet connection 30 (320) using Java's built-in socket library or libraries. If the internet connection 30 is available, the vessel data is transmitted in real-time to the remote server 200 via the third interface 130 (330) using direct SSL port communication. The data may be formatted in a proprietary string based format before transmission. If the internet connection 30 is unavailable, the vessel data is stored in the data cache (340), which may be implemented using Artemis, a distributed in-memory key-value store. The software application continues to monitor the internet connection 30 (350) at regular intervals using a background task managed by a library such as Quartz. Upon detecting a reconnection of the internet connection 30, the software application retrieves the stored vessel data from the Artemis data cache and transmits it to the remote server 200 (360) using direct SSL port communication. The software application also receives user-specified configuration settings from the remote server 200 (370) via HTTP POST requests, allowing parameters to be sent within the body rather than as part of the URL. These configuration settings, which may be in a proprietary format, define the vessel data to be transmitted and a transmission frequency. The software application, using proprietary configuration management code, applies the configuration settings to control the transmission of the vessel data (380). Throughout the process, the software application may encrypt the vessel data prior to transmission and decrypt the configuration settings received from the remote server 200 to ensure data security, all handled within the proprietary code. The software application runs as a service on the computing device 140, enabled by process management tools, allowing for headless operation and remote access via the remote server 200, which may host a web-based control panel. In some embodiments the remote access is handled using the remote control computer software Team Viewer.

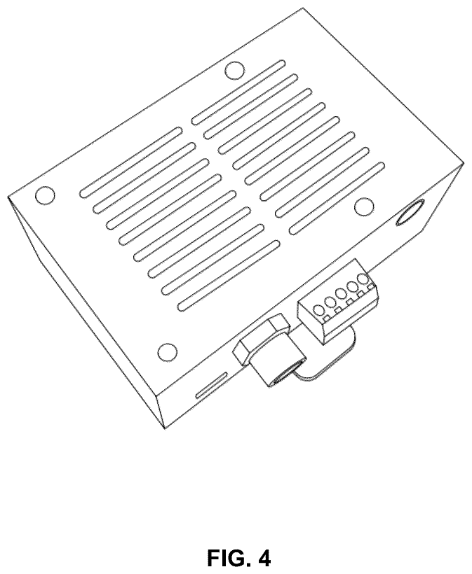

FIG. 4 is an illustrative overview of a hardware embodiment for the system for remotely monitoring marine vessel data. This figure depicts the system in its physical form revealing a complete hardware implementation.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

Although specific embodiments have been illustrated and described herein for purposes of description of the preferred embodiment, it will be appreciated by those of ordinary skill in the art that a wide variety of alternate and/or equivalent implementations may be substituted for the specific embodiment shown and described without departing from the scope of the present invention. Those with skill in the related technical field of the present invention will readily appreciate that the present invention may be implemented in a wide variety of embodiments. This application is intended to cover any adaptations or variations of the preferred embodiments discussed herein. Therefore, it is manifestly intended that this invention be limited only by the claims and the equivalents thereof. It should be appreciated and understood that the present invention may be embodied as systems, methods, apparatus, computer readable media, non-transitory computer readable media and/or computer program products.

The present invention may take the form of an entirely hardware embodiment. an entirely software embodiment (including firmware, resident software, micro-code, etc.) or an embodiment combining software and hardware aspects that may all generally be referred to herein as a “circuit.” “module” or “system.” The present invention may take the form of a computer program product embodied in one or more computer readable mediums) having computer readable program code embodied thereon.

One or more computer readable medium(s) may be utilized. alone or in combination. The computer readable medium may be a computer readable storage medium or a computer readable signal medium. A suitable computer readable storage medium may be, for example, but not limited to, an electronic, magnetic, optical, electromagnetic, infrared, or semiconductor system, apparatus, or device, or any suitable combination of the foregoing. Other examples of suitable computer readable storage medium include, without limitation, the following: an electrical connection having one or more wires, a portable computer diskette, a hard disk, a random access memory (RAM), a read-only memory (ROM), an erasable programmable read only memory (EPROM or flash memory), an optical fiber. an optical storage device, a magnetic storage device, or any suitable combination of the foregoing. A suitable computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Python, C++ or the like and conventional procedural programming languages, such as the “C” programming language or similar programming languages. The program code may execute entirely on the user's computing device (such as, a computer), partly on the user's computing device, as a stand-alone software package, partly on the user's computing device and partly on a remote computing device or entirely on the remote computing device or server. In the latter scenario, the remote computing device may be connected to the user's computing device through any type of network, including a local area network (LAN) or a wide area network (WAN), or the connection may be made to an external computing device (for example, through the Inter-net using an Internet Service Provider).

The present invention is described herein with reference to flowchart illustrations and/or block diagrams, can be implemented by computer program instructions. These computer program instructions may be provided to a processor of a general purpose computing device (such as, a computer), special purpose computing device, or other programmable data processing apparatus to produce a machine, such that the instructions, which execute via the processor of the computing device or other programmable data processing apparatus, create means for implementing the functions/acts specified in the flowchart and/or block diagram block or blocks.

These computer program instructions may also be stored in a computer readable medium that can direct a computing device, other programmable data processing apparatus, or other devices to function in a particular manner, such that the instructions stored in the computer read-able medium produce an article of manufacture including instructions which implement the function/act specified in the flowchart and/or block diagram block or blocks.

The computer program instructions may also be loaded onto a computing device, other programmable data processing apparatus, or other devices to cause a series of operational steps to be performed on the computing device, other programmable apparatus or other devices to produce a computer implemented process such that the instructions which execute on the computing device or other programmable apparatus provide processes for implementing the functions/acts specified in the flow chart and/or block diagram block or blocks.

It should be appreciated that the function blocks or modules shown in the drawings illustrate the architecture, functionality, and operation of possible implementations of systems, methods and computer program media and/or products according to various embodiments of the present invention. In this regard, each block in the drawings may represent a module, segment, or portion of code, which comprises one or more executable instructions for implementing the specified logical function(s). It should also be noted that, in some alternative implementations, the functions noted in the block may occur out of the order noted in the figures. For example, the function of two blocks shown in succession may, in fact, be executed substantially concurrently, or the blocks may sometimes be executed in the reverse order, depending upon the functionality involved.

It will also be noted that each block and combinations of blocks in any one of the drawings can be implemented by special purpose hardware-based systems that perform the specified functions or acts, or combinations of special purpose hardware and computer instructions. Also, although communication between function blocks or modules may be indicated in one direction on the drawings, such communication may also be in both directions.

What is claimed is:

1. A system for remotely monitoring marine vessel data, comprising:
a computing device having a processor, a memory, and a plurality of communication interfaces, wherein the plurality of communication interfaces include a first interface configured to connect to a vessel's NMEA 0183 data system, a second interface configured to connect to the vessel's NMEA 2000 data system, and a third interface configured to connect to the vessel's internet connection;
a data cache configured to store vessel data; and
a software application stored in the memory and executed by the processor, the software application configured to:
receive, via the first and second interfaces, vessel data from the NMEA 0183 and NMEA 2000 data systems;
transmit, via the third interface, the vessel data in real-time to a remote server using the vessel's internet connection;
store the vessel data in the data cache when the vessel's internet connection is unavailable; and
transmit the stored vessel data to the remote server upon reconnection of the vessel's internet connection.

2. The system of claim 1, wherein the software application is further configured to:
receive, from the remote server, user-specified configuration settings defining the vessel data to be transmitted and a transmission frequency; and
apply the user-specified configuration settings to control the transmission of the vessel data.

3. The system of claim 1, wherein the computing device is a single-board computer comprising a Raspberry Pi.

4. The system of claim 1, further comprising: a CAN bus interface board communicatively coupled to the computing device, the CAN bus interface board providing the interface for connecting to the vessel's NMEA 2000 data system.

5. The system of claim 4, wherein the CAN bus interface board is a PiCAN-M board.

6. The system of claim 1, further comprising: a serial bus interface board communicatively coupled to the computing device, the serial bus interface board providing the interface for connecting to the vessel's NMEA 0183 data system.

7. The system of claim 1, further comprising an enclosure housing the computing device, wherein the enclosure is one of a custom 3D-printed enclosure or a stock enclosure provided with the CAN bus interface board.

8. The system of claim 1, wherein the computing device further comprises a heatsink attached to the processor.

9. The system of claim 1, wherein the software application is configured to run as a service on the computing device.

10. The system of claim 1, wherein the software application is remotely configurable via the remote server.

11. The system of claim 1, wherein the software application is further configured to:
detect an interruption in the vessel's internet connection;
and automatically transmit the stored vessel data to the remote server upon detecting a reconnection of the vessel's internet connection.

12. The system of claim 1, wherein the vessel data comprises at least one of GPS data, speed data, heading data, wind data, depth data, and engine performance data.

13. The system of claim 1, wherein the software application is further configured to:
process the vessel data received from the NMEA 0183 and NMEA 2000 data systems to generate processed vessel data; and
transmit the processed vessel data to the remote server.

14. The system of claim 1, wherein the computing device is configured for headless operation and remote access.

15. The system of claim 1, wherein the data cache is configured to store the vessel data in a queue for transmission to the remote server.

16. The system of claim 1, wherein the software application is further configured to:
encrypt the vessel data prior to transmitting the vessel data to the remote server; and
decrypt the user-specified configuration settings received from the remote server.

17. A method for remotely monitoring marine vessel data, comprising:
connecting a computing device to a vessel's NMEA 0183 data system via a first communication interface of the computing device;
connecting the computing device to the vessel's NMEA 2000 data system via a second communication interface of the computing device;
connecting the computing device to the vessel's internet connection via a third communication interface of the computing device;
receiving, by the computing device via the first and second communication interfaces, vessel data from the NMEA 0183 and NMEA 2000 data systems;
transmitting, by the computing device via the third communication interface and the internet connection, the received vessel data in real-time to a remote server;
detecting, by the computing device, that the internet connection is unavailable;
storing, in response to detecting the internet connection is unavailable, the received vessel data in a data cache of the computing device;
detecting, by the computing device, that the internet connection has been re-established;
transmitting, in response to detecting the internet connection has been re-established, the vessel data stored in the data cache to the remote server; and
providing, by the remote server, remote access to the received vessel data to authorized users.

18. The method of claim 17, further comprising:
receiving, from the remote server, user-specified configuration settings defining the vessel data to be transmitted and a transmission frequency; and
applying the user-specified configuration settings to control the transmission of the vessel data.

19. The method of claim 17, wherein the computing device is a single-board computer comprising a Raspberry Pi.

20. The method of claim 17, wherein connecting to the vessel's NMEA 2000 data system comprises connecting via a CAN bus interface board communicatively coupled to the computing device.

21-29. (canceled)
